(19) United States
(12) Patent Application Publication
(10) Pub. No.: US 2014/0314388 A1
(43) Pub. Date: Oct. 23, 2014

(54) STRAIN RELIEF DEVICE FOR A FIBER OPTIC CABLE

(71) Applicant: Tyco Electronics Raychem BVBA, Kessel-Lo (BE)

(72) Inventors: Roger Alaerts, Aarschot (BE); Eric Schurmans, Hogen-geetbets (BE)

(73) Assignee: Tyco Electronics Raychem BVBA, Kessel-Lo (BE)

(21) Appl. No.: 14/366,947

(22) PCT Filed: Dec. 5, 2012
(86) PCT No.: PCT/EP2012/074547

§ 371 Date: Jun. 19, 2014

Related U.S. Application Data
(60) Provisional application No. 61/577,523, filed on Dec. 19, 2011.

(51) Int. Cl. G02B 6/44

(52) U.S. Cl. CPC G02B 6/4477
USPC 385/135; 385/137

(57) ABSTRACT

A strain relief device (24) for anchoring a fiber optic cable (22) to telecommunications equipment (10) includes a base (34) defining a top side (52) and a bottom side (54), the base (34) defining a base channel (60) having an open top and a closed bottom and that receives the fiber optic cable (22) from the open top, the base channel (60) defining a longitudinal axis (62) generally parallel to a longitudinal axis (82) of the fiber optic cable (22) when the fiber optic cable (22) is placed within the base channel (60), the base (34) further defining a first sliding coupling structure (66) extending at a generally acute angle relative to the longitudinal axis (62) of the base channel (60) along a top to bottom direction. The strain relief device (24) further including a cover (44) defining a top side and a bottom side, the cover (44) defining a cover channel (80) having an open bottom and a closed top and that receives the fiber optic cable (22) from the open bottom, the cover channel (80) defining a longitudinal axis (78) generally parallel to the longitudinal axis (82) of the fiber optic cable (22) when the fiber optic cable (22) is placed within the cover channel (80), the cover (44) further defining a second sliding coupling structure (68) extending at a generally acute angle relative to the longitudinal axis (78) of the cover channel (80) along a top to bottom direction, the second sliding coupling structure (68) slidably mating with the first sliding coupling structure (66) for clamping the fiber optic cable (22) in between the base (34) and the cover (44).

### TECHNICAL FIELD

The present disclosure relates generally to equipment used in fiber optic communications networks. More particularly, the present disclosure relates to strain relief devices used in securing fiber optic cables to telecommunications equipment.

### BACKGROUND

Fiber optic communication systems are becoming prevalent in part because service providers want to deliver high band width communication capabilities to customers. Fiber optic communication systems employ a network of fiber optic cables to transmit large volumes of data and voice signals over relatively long distances. A typical fiber optic network may include a system of trunk fiber optic cables including optical fibers. Fiber optic networks may include drop cables that interconnect to fibers of the trunk cables at various locations along the lengths of the trunk cables. The drop cables can be routed from the trunk cables to subscriber locations or to intermediate structures such as drop terminals.

Optical fibers of cables (e.g., drop cables, trunk cables, etc.) may often be connected to optical fibers of other cables in the network via splices (e.g., fusion splices). Splices are typically supported within splice trays. Splice trays protect splices (e.g., fusion splices) and manage the optical fibers routed to and from splice locations.

Being part of a fiber optic network, cables routed to and from telecommunications equipment such as splice trays may be exposed to pulling forces. It is desirable to provide effective strain relief for fiber optic cables that are secured or anchored to devices such as splice trays to limit damage to optical fibers within the cables.

### SUMMARY

Certain aspects of the present disclosure relate to effective arrangements for providing strain relief to fiber optic cables secured to telecommunications equipment such as splice trays.

According to one inventive aspect, the disclosure relates to a strain relief device for anchoring a fiber optic cable to telecommunications equipment, the strain relief device comprising a base defining a base channel having an open top and configured to receive at least a portion of the fiber optic cable from the open top, the base channel defining a longitudinal axis generally parallel to a longitudinal axis of the fiber optic cable when the fiber optic cable is placed within the base channel, the base further defining a first sliding coupling structure extending at a generally acute angle with respect to the longitudinal axis of the base channel along a top to bottom direction. The strain relief device further includes a cover defining a cover channel having an open bottom and configured to receive at least a portion of the fiber optic cable from the open bottom, the cover channel defining a longitudinal axis generally parallel to the longitudinal axis of the fiber optic cable when the fiber optic cable is placed within the cover channel, the cover further defining a second sliding coupling structure extending at a generally acute angle with respect to the longitudinal axis of the cover channel along a top to bottom direction, the first and second sliding coupling structures configured to slidably mate for advancing the cover channel toward the base channel to clamp the fiber optic cable in between the base and the cover.

According to another inventive aspect, the disclosure relates to a strain relief device for anchoring a fiber optic cable to telecommunications equipment, the strain relief device comprising a base defining a top side and a bottom side, the base defining a base channel having an open top and a closed bottom and configured to receive at least a portion of the fiber optic cable from the open top, the base channel defining a longitudinal axis generally parallel to a longitudinal axis of the fiber optic cable when the fiber optic cable is placed within the base channel, the base further defining a first sliding coupling structure extending at a generally acute angle with respect to the longitudinal axis of the base channel along a top to bottom direction. The strain relief device further includes a cover defining a top side and a bottom side, the cover defining a cover channel having an open bottom and a closed top and configured to receive at least a portion of the fiber optic cable from the open bottom, the cover channel defining a longitudinal axis generally parallel to the longitudinal axis of the fiber optic cable when the fiber optic cable is placed within the cover channel, the cover further defining a second sliding coupling structure extending at a generally acute angle with respect to the longitudinal axis of the cover channel along a top to bottom direction, the first and second sliding coupling structures configured to slidably mate for advancing the closed top of the cover channel toward the closed bottom of the base channel to clamp the fiber optic cable in between the base and the cover.

According to another inventive aspect, the disclosure relates to a strain relief device for anchoring a fiber optic cable to telecommunications equipment, the strain relief device comprising a base defining a bore having a tapered profile, wherein the bore defines a larger cross dimension at a first end than at a second end of the bore and a clamp structure defining a body configured for insertion into the bore, the body defining a tapered profile, wherein the body defines a larger cross dimension at a first end than at a second end of the body, the clamp structure further including a throughhole extending generally along a direction from the first end to the second end of the body for receiving a fiber optic cable. The base and the clamp structure are configured such that when the clamp structure is slidably inserted into the bore in a direction extending from the first end toward the second end of the bore, a fiber optic cable extending through the throughhole of the clamp structure is radially clamped within the clamp structure.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosure herein are based.

### BRIEF DESCRIPTION OF THE DRAWINGS

FIG. 1 is a top perspective view of a fiber management tray according to the present disclosure;

FIG. 2 is another top perspective view of the fiber management tray of FIG. 1;

FIG. 3 is a bottom perspective view of the fiber management tray of FIG. 1;

FIG. 4 is a top plan view of the fiber management tray of FIG. 1;

FIG. 5 is a side view of the fiber management tray of FIG. 1;

FIG. 6 is a front perspective exploded view of a strain relief device having features that are examples of inventive aspects in accordance with the principles of the present disclosure, the strain relief device shown with an insert for converting the size of the channel of the base of the strain relief device for different sized cable;

FIG. 7 illustrates the strain relief device of FIG. 6 in an assembled configuration;

FIG. 8 is a rear perspective exploded view of the strain relief device of FIG. 6;

FIG. 9 illustrates the strain relief device of FIG. 8 in an assembled configuration;

FIG. 10 illustrates the clamping direction of the cover of the strain relief device with respect to the base of the strain relief device for clamping a cable;

FIG. 11 is a top front perspective view of the base of the strain relief device of FIGS. 6-9;

FIG. 12 is a top rear perspective view of the base of FIG. 11;

FIG. 13 is a bottom rear perspective view of the base of FIG. 11;

FIG. 14 is a side view of the base of FIG. 11;

FIG. 15 is a top view of the base of FIG. 11;

FIG. 16 is a rear view of the base of FIG. 11;

FIG. 17 is a top front perspective view of the cover of the strain relief device of FIGS. 6-9;

FIG. 18 is a top rear perspective view of the cover of FIG. 17;

FIG. 19 is a bottom rear perspective view of the cover of FIG. 17;

FIG. 20 is a side view of the cover of FIG. 17;

FIG. 21 is a bottom view of the cover of FIG. 17;

FIG. 22 is a rear view of the cover of FIG. 17;

FIG. 23 illustrates the clamping of a strength member of a fiber optic cable to the strain relief device of FIGS. 6-9;

FIG. 24 is perspective view a first embodiment of an insert for use with the strain relief device of FIGS. 6-9;

FIG. 25 is a side view of the insert of FIG. 24;

FIG. 26 is a top view of the insert of FIG. 24;

FIG. 27 is a front view of the insert of FIG. 24;

FIG. 28 is perspective view another embodiment of an insert for use with the strain relief device of FIGS. 6-9;

FIG. 29 is a side view of the insert of FIG. 28;

FIG. 30 is a top view of the insert of FIG. 28;

FIG. 31 is a front view of the insert of FIG. 28;

FIG. 32 is a front perspective exploded view of another embodiment of a strain relief device having features that are examples of inventive aspects in accordance with the principles of the present disclosure;

FIG. 33 is a partial exploded view of the strain relief device of FIG. 32;

FIG. 34 illustrates the strain relief device of FIG. 32 in an assembled configuration;

FIG. 35 is a front perspective view of the base of the strain relief device of FIGS. 32-34;

FIG. 36 is a front perspective view of a first clamp structure of the strain relief device of FIGS. 32-34; and

FIG. 37 is a cover that can be used to retain the first clamp structure within the base of the strain relief device of FIGS. 32-34.

### DETAILED DESCRIPTION

The present disclosure relates to arrangements and methods for providing effective strain relief to fiber optic cables that are anchored to telecommunications equipment.

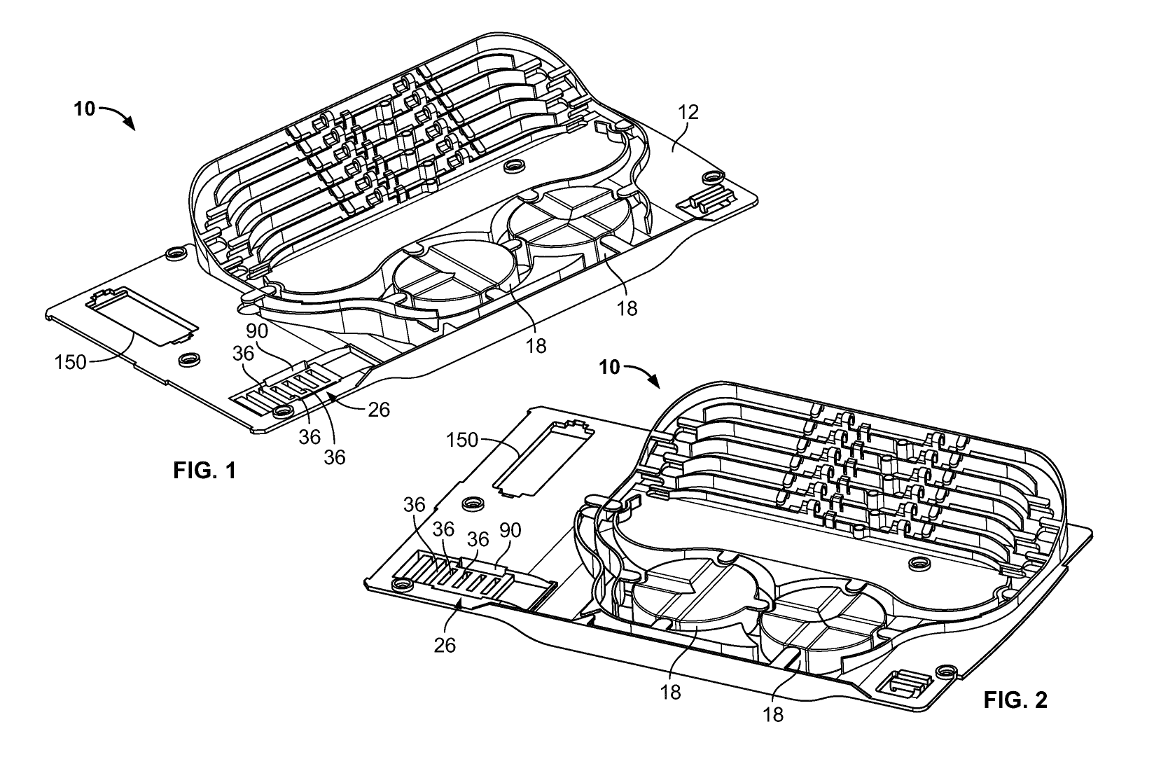

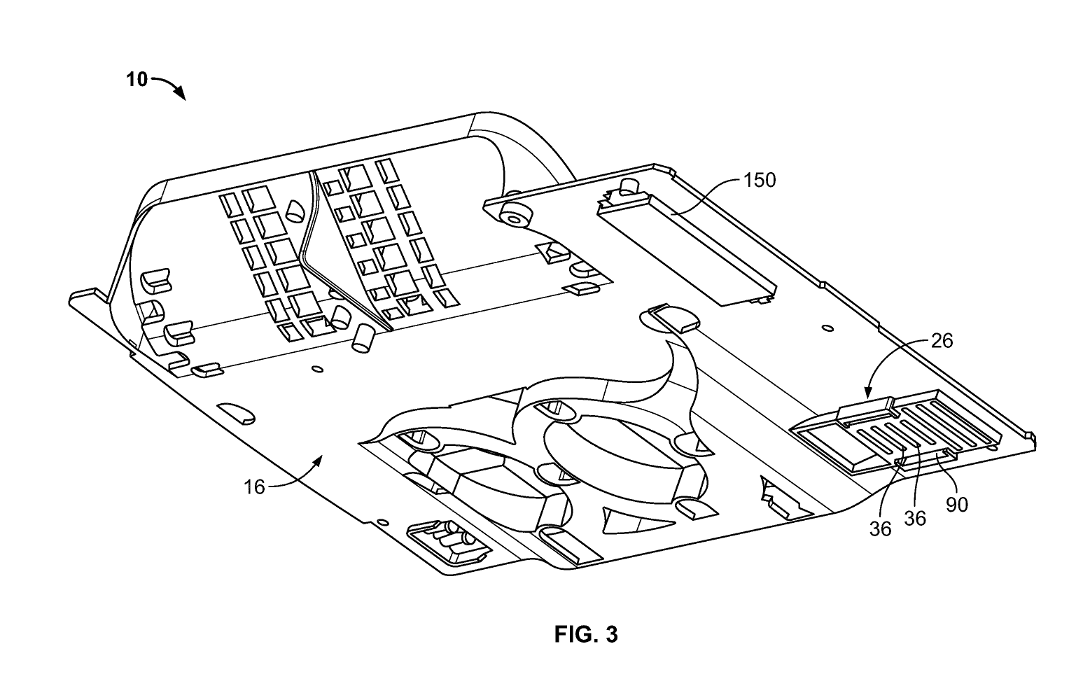

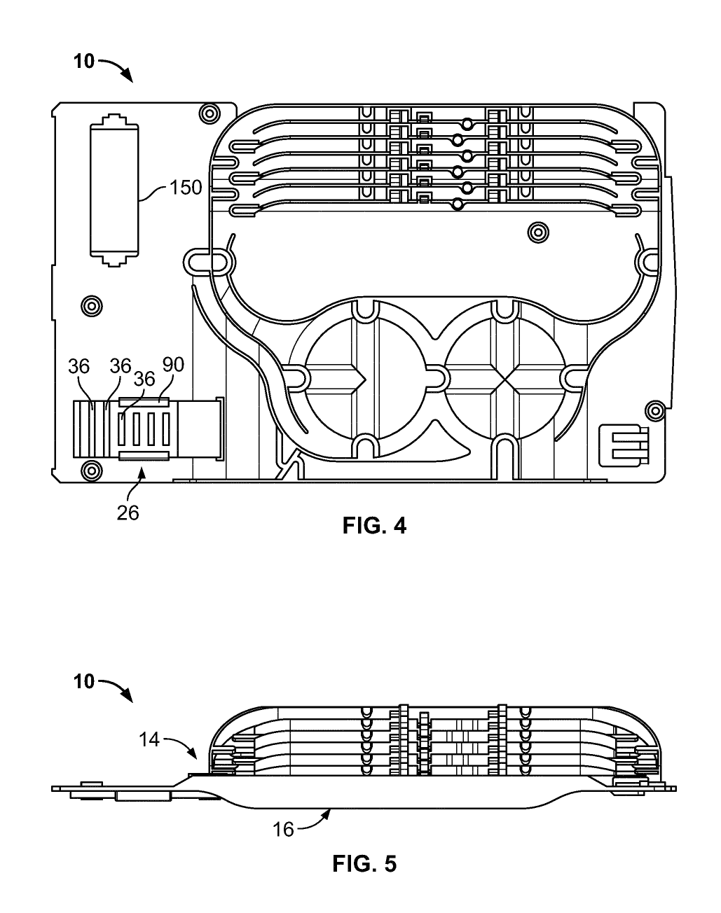

Referring to FIGS. 1-5, a telecommunications fixture in the form of a fiber management tray 10 is illustrated. The fiber management tray 10 includes a generally planar main body 12 defining a top side 14 and a bottom side 16. The tray 10 includes one or more fiber management structures 18 that are provided on the top side 14 of the tray 10. Optical fibers 20 of cables 22 entering the tray 10 may be routed through the one or more fiber management structures 18 and connected to optical fibers of other cables via splices (e.g., fusion splices) within the tray 10. The fiber management tray 10 may also be referred to as a splice tray 10 in the present disclosure.

As will be discussed in further detail below, according to certain example applications, a fiber optic cable 22 entering the tray 10 may clamped to the tray 10 so as to reduce strain on the optical fibers 20 if the cable is exposed to pulling forces away from the tray 10. Once clamped, a number of the fibers 20 of the cable 22 may be broken out and routed through the one or more fiber management structures 18 for further splicing to fibers of other cables. Portions of the cable 22 that are not broken out may continue to the other end of the tray 10, wherein the cable 22 may once again be clamped or anchored to reduce strain on fibers caused by pulling forces originating from an exterior of the tray 10.

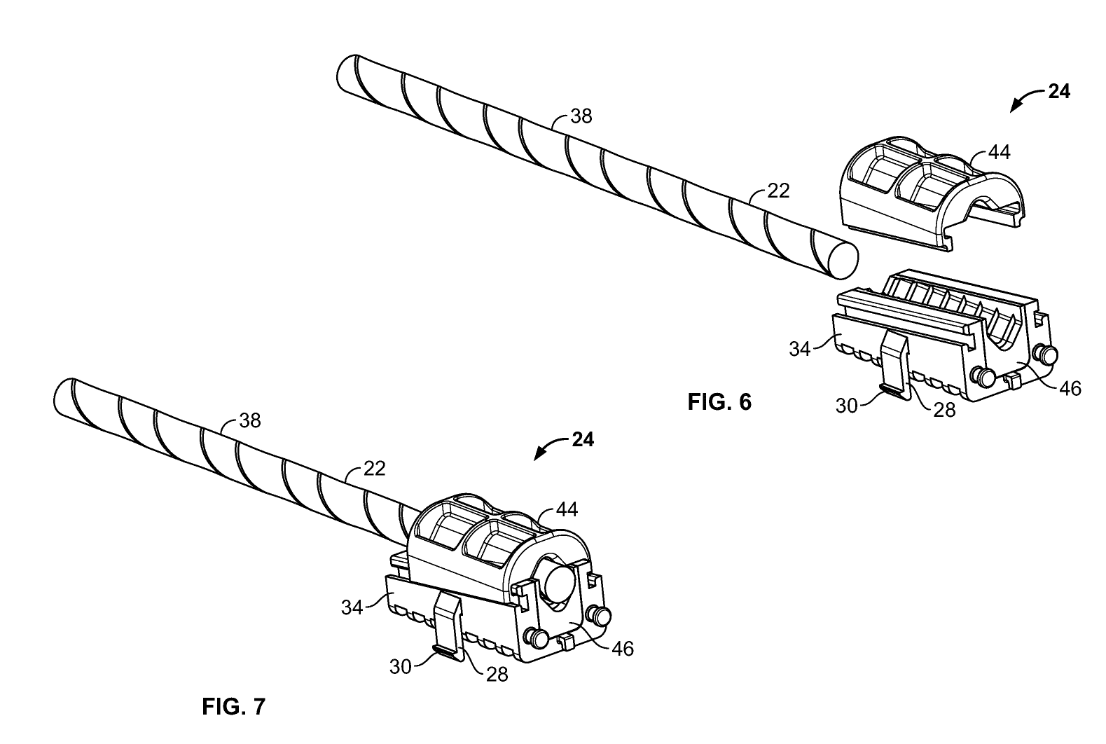

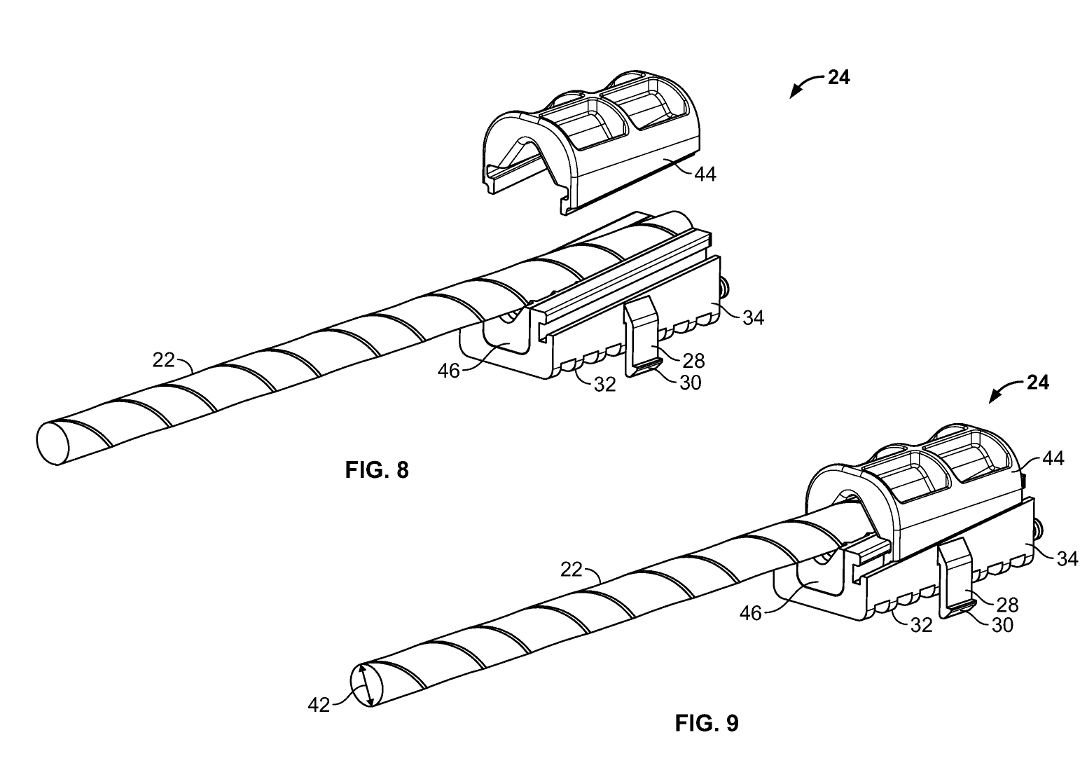

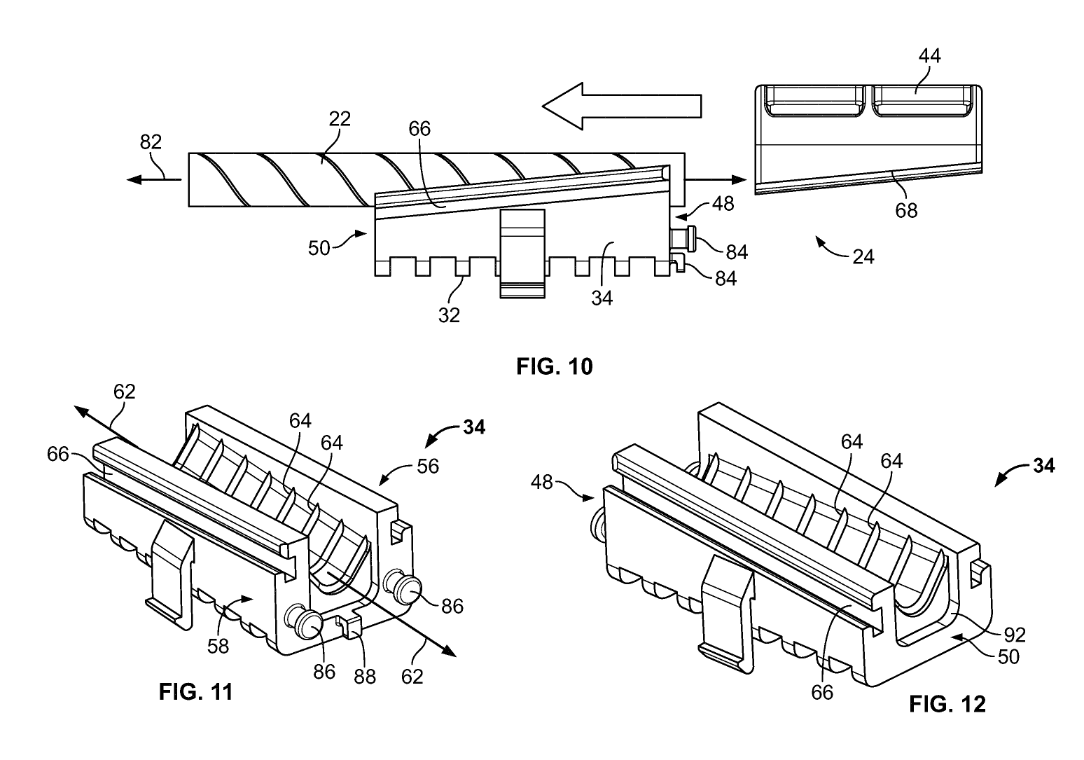

Referring now to FIGS. 6-10, a removable strain relief device 24 that is configured for coupling to the fiber management tray 10 is shown, the strain relief device 24 including features that are examples of inventive aspects in accordance with the present disclosure. The strain relief device 24 can also be referred to as a cable clamp 24 and is generally configured to provide strain relief against pulling forces to a fiber optic cable 22 that is anchored to the tray 10. The strain relief device 24 is configured to be removably mounted to a cable clamp mount portion 26 of the tray 10, shown in FIGS. 1-5.

In the depicted embodiment, the strain relief device 24 is configured to be coupled to the tray 10 via a snap-fit interlock. According to the depicted example embodiment, the strain relief device 24 includes a pair of elastically flexible cantilever arms 28 with ramped tab portions 30. The cantilever arms 28 are configured to flex elastically inwardly and outwardly when the cable clamp 24 is being coupled to or removed from the mount portion 26 of the tray 10. The ramped tab portions 30 of the arms 28 act as catches to prevent removal after the clamp 24 has been mounted to the tray 10.

As will be described in further detail below, the cable clamp 24, in the depicted embodiment, also includes a plurality of ribs 32 along a base portion 34 of the clamp 24 that are configured to fit within keying slots 36 defined at the cable clamp mount 26 of the tray 10 for keying with and nesting within the mount 26.

It should be noted that the fiber management or splice tray 10 shown is simply one example of a piece of telecommunications equipment which the strain relief device 24 may be used with and is referred to and illustrated herein to describe the inventive aspects of the strain relief device 24. The strain relief device 24 can be used with a variety of other telecommunications equipment wherein a fiber optic cable 22 is anchored or secured to the equipment.

It should also be noted that although the strain relief device 24 is shown herein as being coupled to the splice tray 10 with a snap-fit interlock, the strain relief device 24 may be coupled to a piece of telecommunications equipment such as the splice tray 10 via a variety of other methods such as via adhesive, via ultrasonic welding, etc. The attachment methods can provide for removability of the strain relief device 24 such as shown or may provide for more permanent fixtures.

Also, even though the snap-fit interlock between the tray 10 and the depicted strain relief device 24 is provided via structures in the form of elastically flexible cantilever arms 28 that have ramped retaining tabs 30, the snap-fit interlock may be provided via other arrangements.

According to one example embodiment, the fiber optic cable 22 includes an outer jacket 38 surrounding one or more optical fibers 20. It will be appreciated that the outer jacket 38 of the cable 22 can be made of any number of different types of polymeric materials. In one embodiment, the outer jacket 38 is made of polyethylene. In the example embodiment, the cable 22 also includes a strength member 40 (i.e., a tensile reinforcing member) positioned within the outer jacket 38. According to one embodiment, the strength member 40 may be formed from flexible Kevlar fibers.

According to one example embodiment, the outer diameter 42 of the outer jacket 38 may be between 2.0 mm and 9.5 mm. According to certain examples, the outer diameter 42 of the outer jacket 38 may be between 8.0 mm and 9.5 mm. According to certain examples, the outer diameter 42 of the outer jacket 38 may be between 6.0 mm and 7.5 mm. According to certain examples, the outer diameter 42 of the outer jacket 38 may be between 4.0 mm and 5.5 mm. According to other example embodiments, the outer diameter 42 of the outer jacket 38 may be between 2.0 mm and 3.0 mm.

As will be described in further detail below, the outer jacket 38 and the strength member 40 of the fiber optic cable 22 is anchored to the splice tray 10 via the strain relief device 24 of the present disclosure. The strain relief device 24 is configured such that after a portion of the outer jacket 38 has been stripped, exposing the one or more optical fibers 20 and the strength member layer 40, the jacket 38 and the strength member 40 are clamped to the tray 10 via the strain relief device 24 and the optical fibers 20 continue to be routed through the tray 10 for splicing.

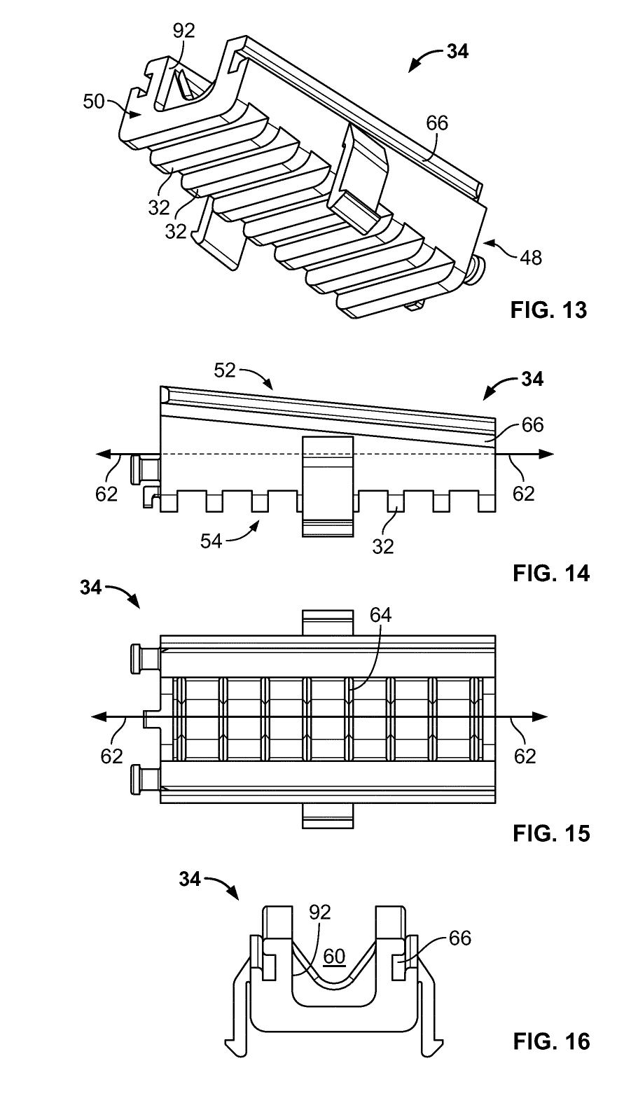

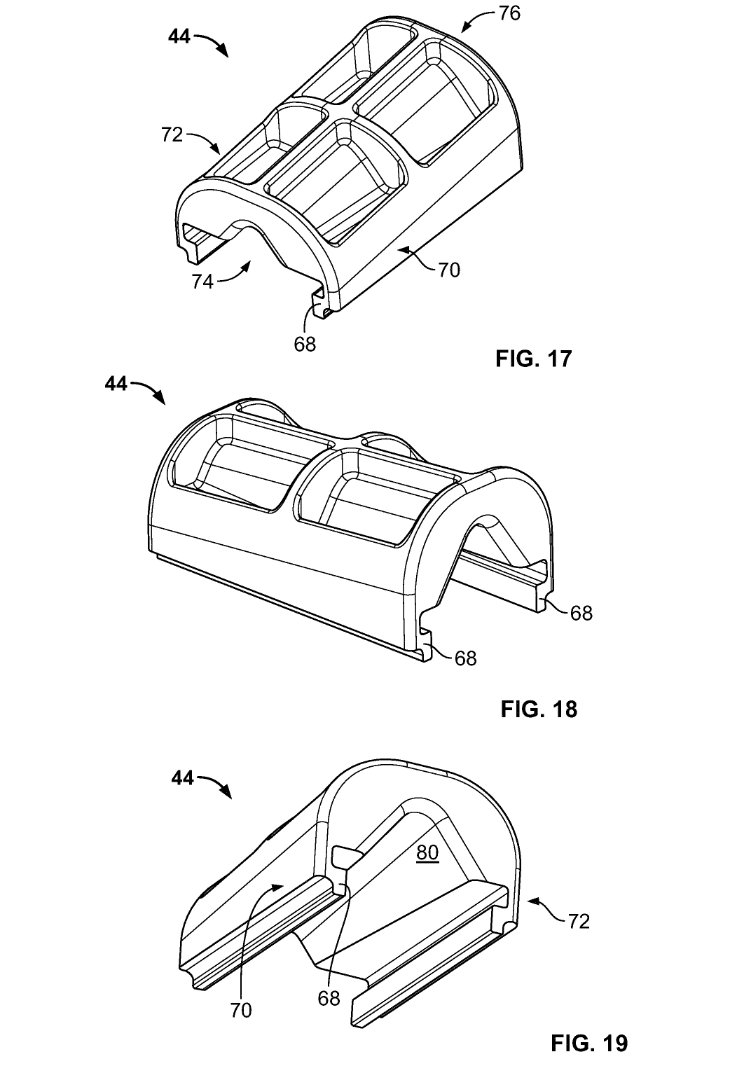

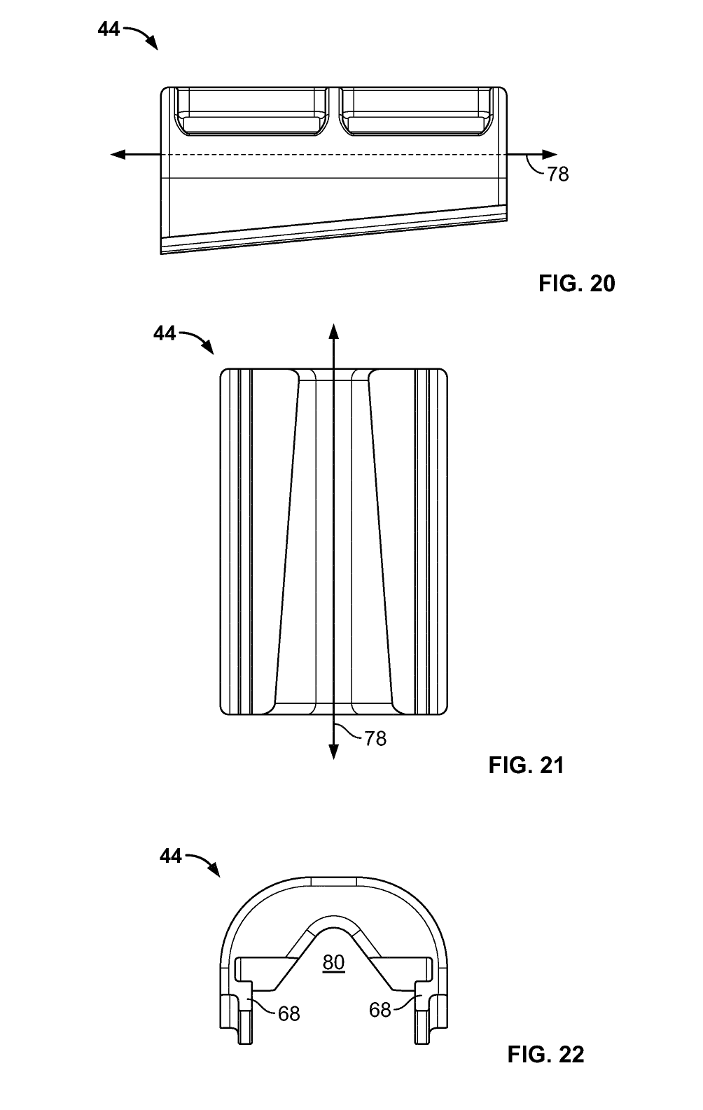

Still referring to FIGS. 6-10, wherein the strain relief device 24 is illustrated in isolation, the strain relief device 24 includes the base 34 and a cover 44 that is configured to be slidably coupled to the base 34 to clamp a fiber optic cable 22 therein. The base 34 is illustrated in FIGS. 11-16 and the cover 44 is illustrated in FIGS. 17-22. As will be described in further detail below, the strain relief device 24 is illustrated with an insert structure 46 in FIGS. 6-10, wherein the insert 46 is used to convert the base 34 of the strain relief device 24 to accommodate a different sized cable 22.

Referring to FIGS. 11-16, the base 34 defines a first end 48 (i.e., front end 48), a second end 50 (i.e., back end 50), a top side 52, a bottom side 54, a right side 56, and a left side 58. The base 34 defines a generally V-shaped channel 60 for placement of the fiber optic cable 22 therein, the channel 60 defining a longitudinal axis 62 that is generally configured to be parallel to that of the fiber optic cable 22 when the cable 22 is laid within the channel 60. Defined along the channel 60 are a series of teeth 64 that are configured to radially cut or bite into the outer jacket 38 of the cable 22 when clamped with the cover 44.

The base 34 defines a first sliding coupling structure (e.g., an elongate groove 66) on each of the right side 56 and the left side 58. As will be discussed further below, each first sliding coupling structure in the form of the groove 66 is configured to receive a second sliding coupling structure in the form of an elongate ridge 68 on each of right and left sides 70, 72 of the cover 44 for clamping the cable 22. The ridges and the grooves 68, 66 define generally a dove-tail configuration such that while they can move with respect to each other in the sliding direction, they cannot be separated in any direction that is perpendicular to the sliding direction. It should be noted that in the depicted example, although the first sliding coupling structure 66 of the base has been provided in the form of a groove and the second sliding coupling structure 68 of the cover has been provided in the form of a ridge, the grooves 66 and the ridges 68 can be interchanged in the other examples to provide for the same functionality.

As shown in FIG. 14, each groove 66 angles downwardly as it extends from the first end 48 to the second end 50 of the base 34, forming a tapered configuration. Each elongate groove 66 extends at an angle that is generally acute with respect to the longitudinal axis 62 of the channel 60 and the cable 22. Similarly, as will be discussed in further detail, each elongate ridge 68 on the cover 44 also extends downwardly from a first end 74 to a second end 76 and at an angle that is acute with respect to the longitudinal axis 78 of a channel 80 defined within the cover 44.

Referring now to FIGS. 17-22, the cover 44 defines the first end 74, the second end 76, and a generally V-shaped channel 80 that extends from the first end 74 to the second end 76. The channel 80 of the cover 44 is similar to the channel 60 of the base 34 in that it defines a longitudinal axis 78 that is generally parallel to a longitudinal axis 82 of the cable 22 and of the channel 60 of the base 34 when the cover 44 is placed over the base 34 in clamping the cable 22. The channel 80 extends from the first end 74 to the second end 76. The channel 80 of the cover 44 is configured to intermate with the channel 60 of the base 34 in receiving the fiber optic cable 22. And, as will be described in further detail below, as the base 34 and the cover 44 slide with respect to each other, the cable 22 is clamped to the strain relief device 24.

When the cover 44 is slid over the base 34 in a direction from first end 48 toward the second end 50 of the base 34, the tapering interaction between the ridges 68 and the grooves 66 provides a radial clamping force on the outer jacket 38 of the cable 22. As the cover 44 is slid in a direction from the first end 48 toward the second end 50 of the base 34, due to the interaction between the ridges 68 and the grooves 66, the V-shaped channel 80 of the cover 44 gets closer to the V-shaped channel 60 of the base 34, applying a radial clamping force on the cable 22.

Regarding clamping of the strength member 40 that is exposed after the outer jacket 38 has been stripped, the base 34 defines a plurality of strength member retention structures 84 at the first end 48 thereof. In the depicted embodiment, the strength member retention structures 84 include a pair of forwardly extending posts 86 and a finger 88 having a downwardly extending portion provided generally thereinbetween.

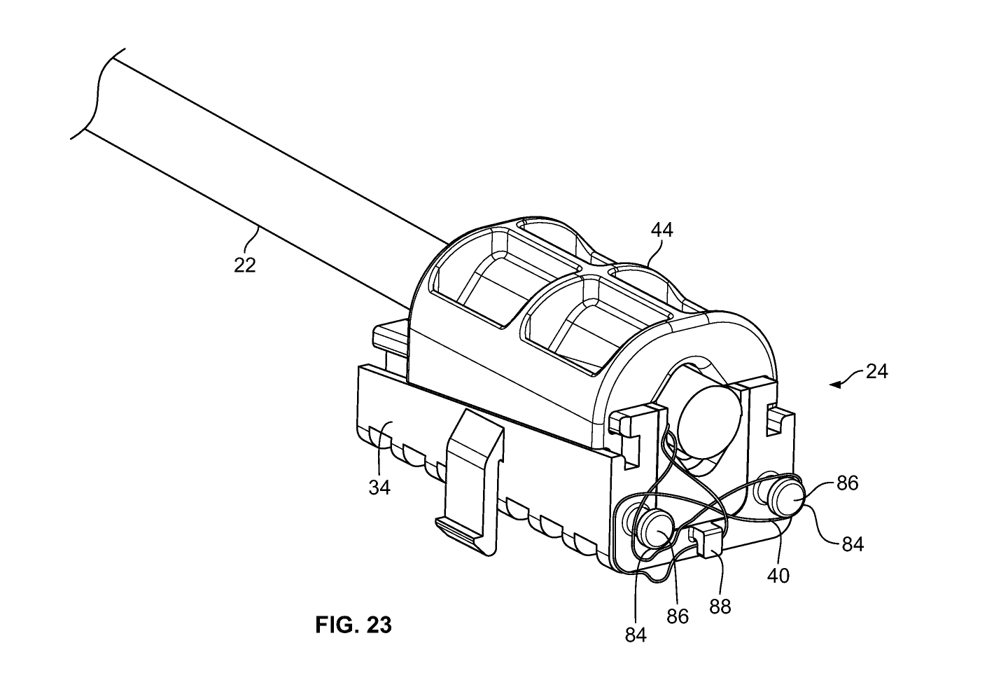

The posts 86 and the finger 88 are configured such that individual strands of a portion of the exposed strength member 40 of the cable 22 can be wrapped therearound (e.g., in a figure-eight configuration) before directing the strength member 40 rearwardly through the channel 60 of the base 34 (see FIG. 23). The V-shape of the channel 60 may provide room in the channel 60 underneath, for example, a generally cylindrical cable 22 for the strength member 40. According to one example method of clamping the cable 22, after the strength member 40 has been wrapped around the retention structures 84 and directed rearwardly within the channel 60 of the base 34, the cable 22 is placed within the channel 60. Thereafter, the cover 44 is slid over the base 34, clamping the cable jacket 38 within the channel 60 over the strength member 40, with the teeth 64 of the channel 60 of the base 34 biting or cutting into the outer jacket 38.

The remaining portion of the strength member 40 that is exposed after the cable 22 is clamped can extend out from the second end 50 of the base 34 away from the telecommunications device.

As noted above, the base 34 may include a pair of elastically flexible cantilever arms 28 with ramped tab portions 30, one provided on each of the right side 56 and the left side 58. The cantilever arms 28 are configured to flex elastically inwardly and outwardly when the stain relief device 24 is being coupled to or removed from the mount portion 26 of the tray 10. The ramped tab portions 30 of the arms 28 act as catches to prevent removal after the clamp 24 has been mounted to the tray 10. As illustrated in FIGS. 1-5, the mount portion 26 of the tray includes a pair of opposing slots 90 for receiving the cantilever arms 28 of the strain relief device 24.

Although illustrated and described with a removable snap-fit interlock, the strain relief device 24 may be coupled to a piece of telecommunications equipment such as the splice tray 10 via a variety of other methods such as via adhesive, via ultrasonic welding, etc. The attachment methods can provide for removability of the strain relief device 24 such as shown or may provide for more permanent fixtures. In other embodiments, portions of the strain relief device 24 such as the base 34 may be integrally formed (e.g., injection molded) with telecommunications equipment such as the splice tray 10.

Also, even though the snap-fit interlock between the tray 10 and the depicted strain relief device 24 is provided by elastically flexible cantilever arms 28 that have ramped retaining tabs 30 and slots 90, the snap-fit interlock may be provided via other arrangements.

As also noted above, the cable clamp 24, in the depicted embodiment, also includes the plurality of ribs 32 along a base portion 34 of the clamp 24 that are configured to fit within keying slots 36 defined at the cable clamp mount 26 of the tray 10 for keying with and nesting within the mount 26.

As noted previously, fiber optic cables 22 may be provided in different sizes, wherein the outer jackets 38 of the cables 22 may define different diameters 42. For example, according to one embodiment, the outer diameter 42 of the outer jacket 38 may be between 8.0 mm and 9.5 mm. According to another embodiment, the outer diameter 42 of the outer jacket 38 may be between 6.0 mm and 7.5 mm. According to yet another embodiment, the outer diameter 42 of the outer jacket 38 may be between 4.0 mm and 5.5 mm.

As shown in FIGS. 6-9 and 24-31, the cable clamp 24 may include inserts 46 that can be placed within the channel 60 of the base 34 to change the configuration of the channel 60.

As shown, the base 34 defines a cutout 92 at each of the first end 48 and the second end 50 that receives a complementary structure at each of the first and second end 94, 96 of an insert 46 for removably placing the insert 46 within the base 34.

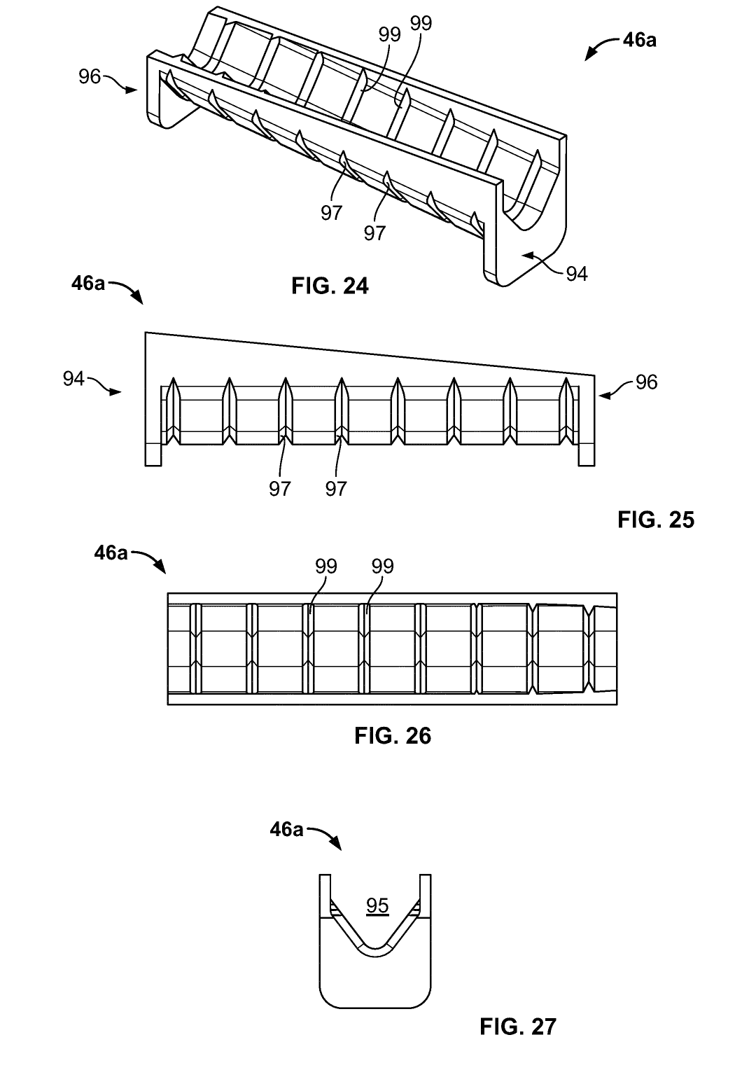

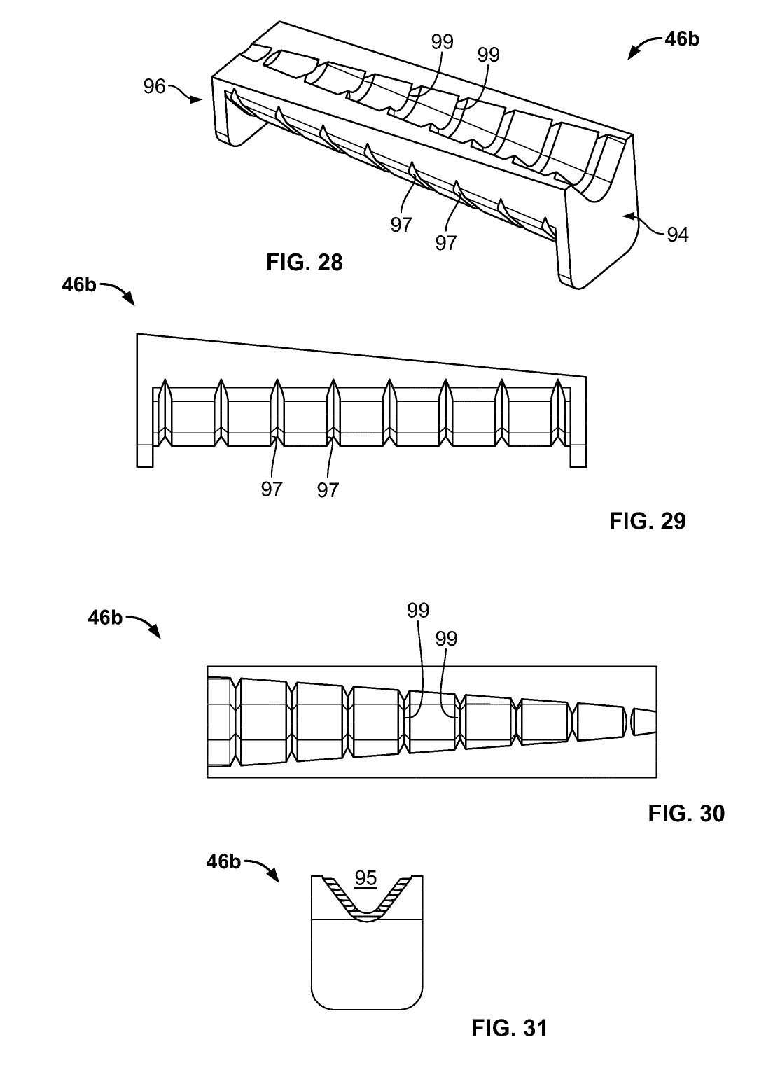

The channel 60 defined by the base 34 (as shown in FIGS. 11-16), without an insert 46 placed therein, is generally configured for clamping a fiber optic cable 22 having an 8.0-9.5 mm outer jacket 38. An insert 46a configured for clamping a fiber optic cable 22 having a 6.0-7.5 mm outer jacket 38 is shown in FIGS. 24-27. An insert 46b configured for clamping a fiber optic cable 22 having a 4.0-5.5 mm outer jacket 38 is shown in FIGS. 28-31.

Each insert 46 also defines a generally V-shaped channel 95 and is configured to change the size of the channel 60 of the base 34 when used. Each insert 46 defines a plurality of notches 97 along the bottom of the insert 46 that are configured to fit over the teeth 64 of the base 34 when placed therein. Each insert 46 also defines similar teeth 99 along the channel 95 thereof for biting into the outer jacket 38 of the cable 22.

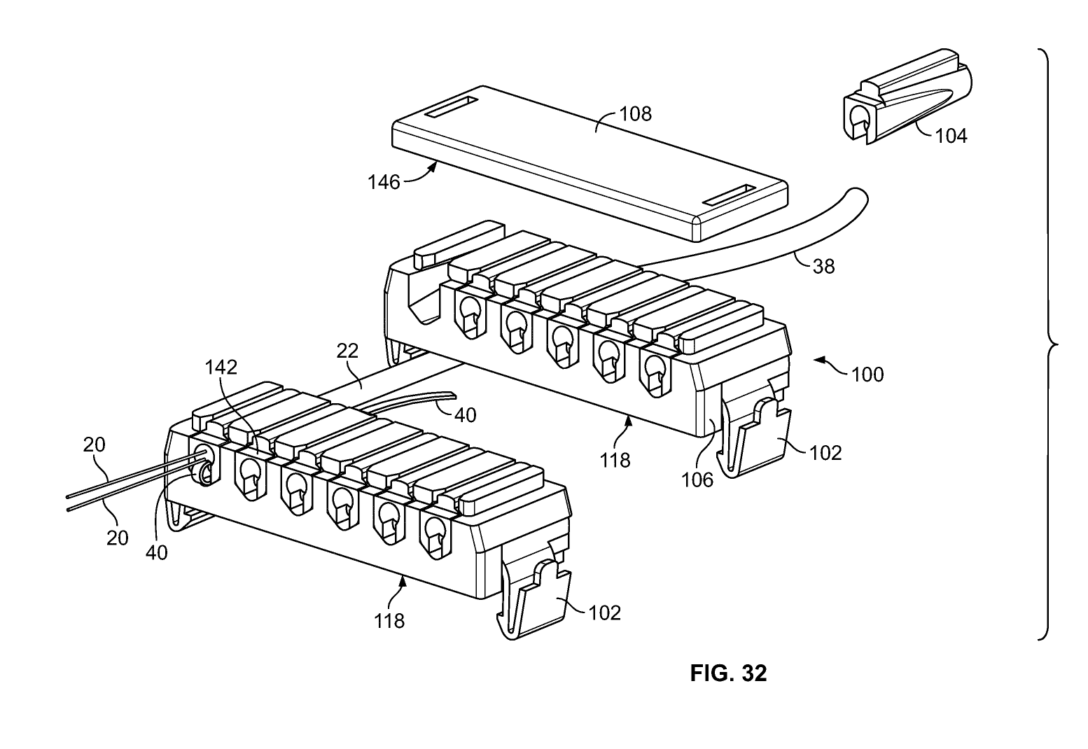

Referring now to FIGS. 32-37, another embodiment of a strain relief device 100 is illustrated. The strain relief device 100 shown in FIGS. 32-37 is similar in function to the device 24 shown in FIGS. 6-31 and can be used in anchoring a fiber optic cable 22 to a piece of telecommunications equipment such as the splice tray 10 of FIGS. 1-5. According to one embodiment, the strain relief device 100 of FIGS. 32-37 may be used to anchor fiber optic cables 22 that are smaller than the cables 22 anchored by the strain relief device 24 and inserts 46 of FIGS. 6-31. For example, according to one example, the strain relief device 100 of FIGS. 32-37 may be used to anchor a fiber optic cable 22 wherein the outer diameter 42 of the outer jacket 38 may be between 2.0 mm and 3.0 mm.

As noted previously, the strain relief device 100 may be mounted to the splice tray 10 via a variety of methods including a snap-fit interlock, via adhesives, via ultrasonic welding, etc. In the depicted embodiment, the strain relief device 100 is illustrated with a pair of elastically flexible cantilever arms 102 for providing a snap-fit interlock with another clamp mount 150 of the splice tray 10, as shown in FIG. 1-4.

Still referring to FIGS. 32-37, in the illustrated example, the strain relief device 100 includes a first clamp structure 104, a second clamp structure 106, and a cover 108 that can be used after the first clamp structure 104 has been inserted into the second clamp structure 106. The second clamp structure 106 may also be referred to herein as the base 106. In the depicted example, the base 106 is configured to receive a plurality of first clamp structures 104, each one configured to anchor a separate fiber optic cable 22 to a piece of telecommunications equipment.

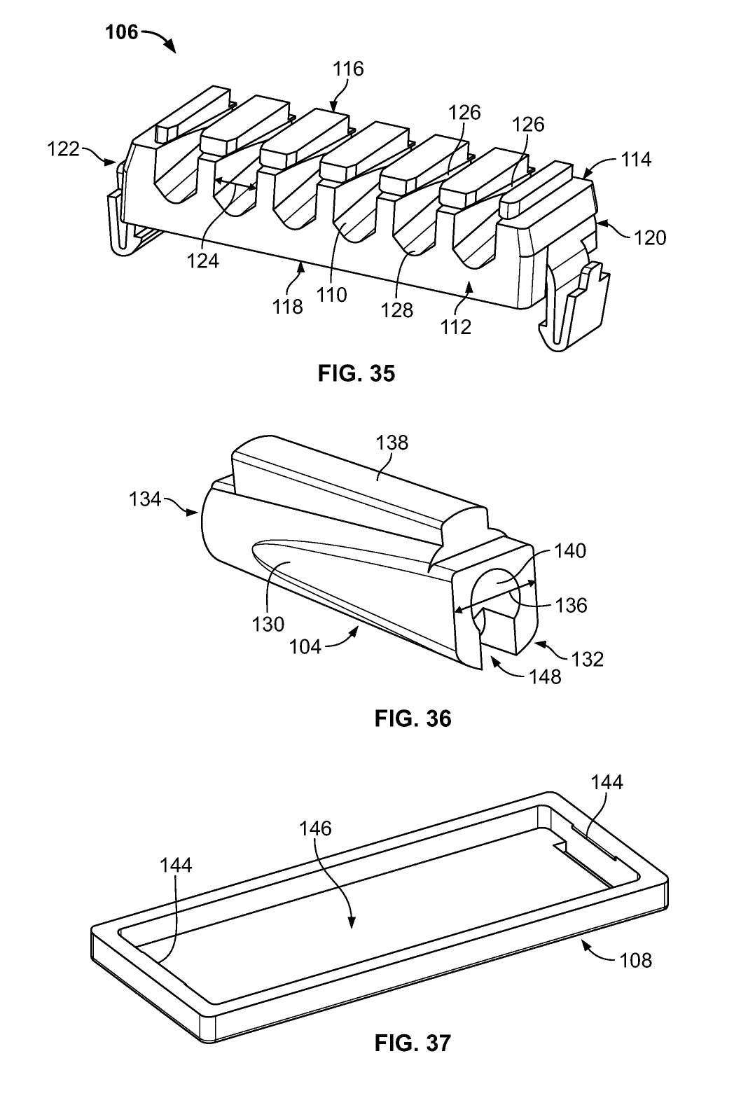

Referring now to FIG. 35, for each first clamp structure 104, the base 106 includes a bore 110 that extends from a first end 112 of the base 106 to a second end 114. The base 106 further defines a top side 116, a bottom side 118, a right side 120 and a left side 122.

Each bore 110 defines a tapered configuration extending from the first end 112 of the base 106 to the second end 114 such that the bore 110 defines a larger cross dimension 124 at the first end 112 that tapers down to a smaller cross dimension 124 at the second end 114, forming a generally conical shape. Above each bore 110 is also defined an elongate groove 126 that extends along the top side 116 of the base 106. The groove 126 communicates with the conical bore 110. As will be discussed in further detail, the groove 126 is configured to provide a keying function with respect to each first clamp structure 104.

For each of the bores 110, the base 106 defines a notch 128 at a bottom side of the bore 110 that extends from the first end 112 to the second end 114 of the base 106. As will be discussed in further detail below, the notch 128 is configured to accommodate a strength member 40 of a fiber optic cable 22 that is anchored using the strain relief device 100.

Referring now to FIG. 36, each first clamp structure 104 defines a shape that is configured for mating with the shape of the bore 110. The first clamp structure 104 defines a main body portion 130 that defines a tapered configuration extending from a first end 132 of the main body 130 to a second end 134 of the main body 130 such that the main body 130 defines a larger cross dimension 136 at the first end 132 that tapers down to a smaller cross dimension 136 at the second end 134, forming a conical shape. The first clamp 104 structure also includes a longitudinally extending ridge 138 that is integrally formed with the main body 130. The ridge 138 extends from adjacent the first end 132 to adjacent the second end 134 of the main body portion 130 and is configured to be slidably inserted within the groove 126 of the base 106 for keying the first clamp structure 104 to each bore 110.

A throughhole 140 of the first clamp structure 104 is configured to receive the outer jacket 38 of the fiber optic cable 22. In the depicted embodiment, once receiving the cable 22 therein, the first clamp structure 104 is slid into the bore 110, with the ridge 138 aligned with the groove 126, in a direction from the first end 112 toward the second end 114. As the first clamp structure 104 is slid toward second end 114 of the base 106, the intermating conical shapes of the bore 110 and the main body 130 provides a radial clamping force on the main body portion 130. This, in turn, provides a clamping force on the outer jacket 38 that is within the throughhole 140.

In the depicted example embodiment, the first clamp structure 104 receives the outer jacket 38 in a direction from the second end 134 to the first end 132 with the exposed fibers extending away from the first end 132 toward a piece of telecommunications device for splicing. In this manner, if the outer jacket 38 is pulled along a direction from the first end 132 toward the second end 134, away from the second end 134, the cable 22 is clamped even tighter due to the tapering interface between the main body 130 and the bore 110.

After the first clamp structures 104 have been inserted into the base 106, as noted above, the cover 108 may be used to limit removal of the first clamp structures 104 from the base 106. The portions of the base 106 that form the elongate grooves 126 and the elongate ridges 138 of the first clamp structure 104 are configured to provide spacing 142 around the top perimeter of the base 106 for receiving the cover 108. The cover 108 can be snap-fit to the base 106 via tabs 144 provided at a bottom side 146 of the cover 108, as shown in FIG. 37. Once the cover 108 is snap-fit to the base 106, the first clamp structure 104 is limited from moving along a longitudinal direction within the bore 110 due to the ridge 138 of the first clamp structure 104 abutting the cover 108.

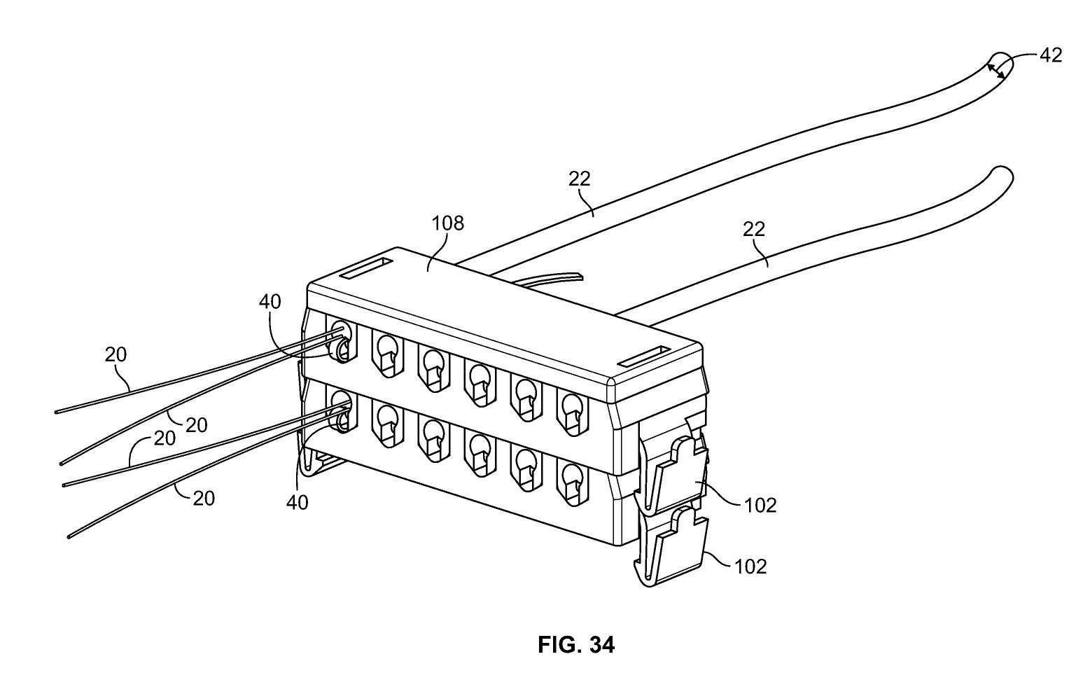

Also, the bottom side 118 of the base 106 of the strain relief device 100 can be configured similar to the bottom side 146 of the cover 108 such that two strain relief devices 100 can be stacked on top of each other, as shown in FIG. 34.

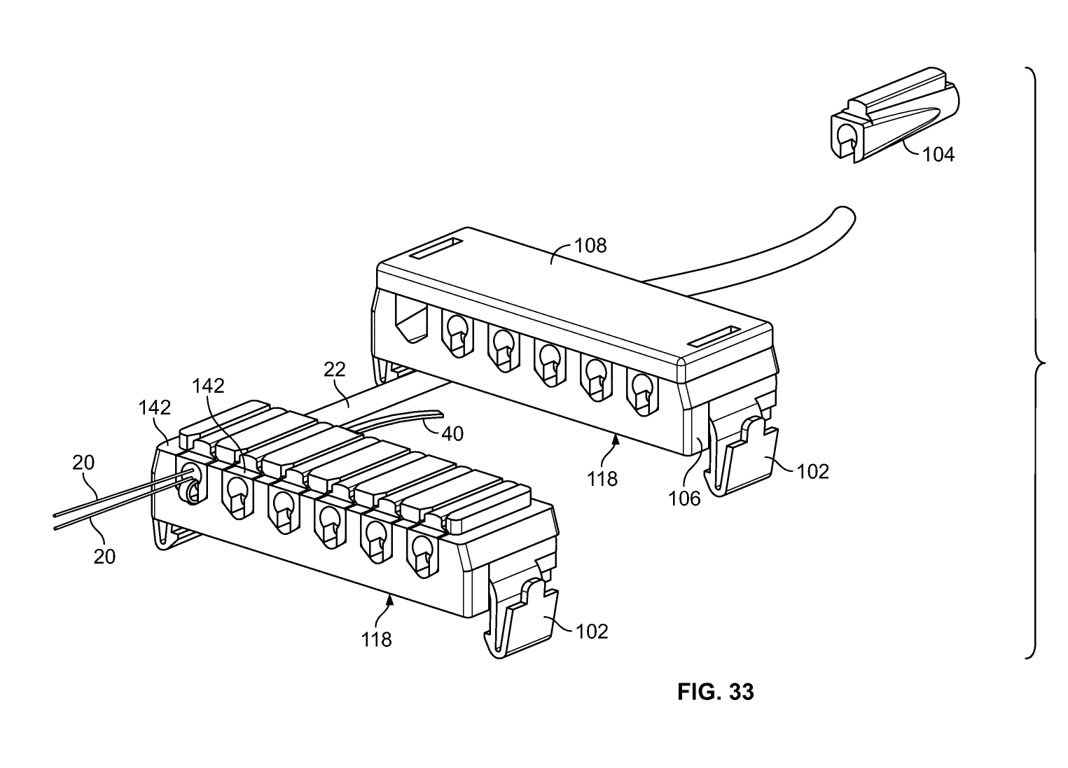

Regarding the clamping of the strength member 40 that is exposed after the outer jacket 38 has been stripped, the first clamp structure 104 defines a cutout 148 at the first end 132 of the main body 130. The cutout 148 is configured to accommodate a downwardly folded portion of the exposed strength member 40. After the strength member 40 is folded downwardly, the strength member 40 is folded rearwardly underneath the first clamp structure 104 as shown in FIGS. 32-34. The portion that is folded underneath the first clamp structure 104 and that extends from the first end 132 to the second end 134 is then nested within each notch 128 of the base 104. As shown in FIGS. 32 and 33, the remaining portion of the strength member 40 that is exposed extends out from the second end 114 of the base 106 away from the telecommunications device.

According to one example method of clamping the fiber optic cable, in order to facilitate the placement of the strength member 40 within the strain relief device 100, the portion of the strength member 40 that is exposed after the outer jacket 38 has been stripped is first folded downwardly and rearwardly underneath the first clamp structure 104. The portion of the strength member 40 that protrudes from the second end 134 of the main body 130 of the first clamp structure 104 after it has been folded is first inserted into the bore 110 and then the first clamp structure 104 is slidably placed within the bore 110, clamping the strength member 40 underneath thereof. And, as the first clamp structure 104 is further slid within the bore 110 of the base 106, the cable 22 gets clamped radially inwardly within the throughhole 140 of the first clamp structure 104.

Thus, according to the embodiments of the strain relief devices 24, 100 discussed above, the devices 24, 100 include a first structure that is moved with respect to a second structure to clamp a cable 22 in between the first structure and the second structure. A strength member 40 of the cable 22, after the outer jacket 38 of the cable 22 has been stripped and the strength member 40 has been exposed, can be folded back and clamped with the cable 22 against strain relief device, while optical fibers of the cable can continue to a piece of telecommunications equipment for splicing. The strain relief devices 24, 100 are configured such that farther the first structure is moved with respect to the second structure, the tighter the cable 22 and the strength member 40 get clamped to the strain relief device 24, 100.

Although in the foregoing description, terms such as “top”, “bottom”, “front”, “back”, “right”, “left”, “upper”, and “lower” may have been used for ease of description and illustration, no restriction is intended by such use of the terms. As discussed previously, the telecommunications equipment such as the strain relief devices and the fiber management trays described herein can be used in any orientation, depending upon the desired application.

From the foregoing detailed description, it will be evident that modifications and variations can be made in the devices or methods of the disclosure without departing from the spirit or scope of the inventive aspects.

### LIST OF REFERENCE NUMERALS AND CORRESPONDING FEATURES

10—Telecommunications fixture/equipment in the form of a fiber management tray/splice tray
12—Main body of tray
14—Top side of tray
16—Bottom side of tray
18—Fiber management structures
20—Optical fiber
22—Cable
24—Strain relief device/cable clamp
26—Clamp mount portion of tray
28—Flexible cantilever arms
30—Ramped tabs
32—Ribs
34—Base of strain relief device
36—Keying slots of clamp mount
38—Outer jacket of cable
40—Strength member of cable
42—Outer diameter of outer jacket
44—Cover of strain relief device
46—Insert for strain relief device
48—First end of base
50—Second end of base
52—Top side of base
54—Bottom side of base
56—Right side of base
58—Left side of base
60—Channel of base
62—Longitudinal axis of base channel
64—Teeth
66—Elongate groove
68—Elongate ridge
70—Right side of cover
72—Left side of cover
74—First end of cover
76—Second end of cover
78—Longitudinal axis of cover channel
80—Channel of cover
82—Longitudinal axis of cable
84—Strength member retention structures
86—Posts
88—Finger
90—Slots of clamp mount portion of tray
92—Cutout of base for insert
95—Channel of insert
99—Teeth of insert
100—2^{nd} Embodiment of strain relief device/cable clamp
102—Flexible cantilever arms
104—First clamp structure of strain relief device
106—Second clamp structure/base of strain relief device
108—Cover of strain relief device
110—Bore of base
112—First end of base
114—Second end of base
116—Top side of base
118—Bottom side of base
120—Right side of base
122—Left side of base
124—Cross dimension of bore
126—Groove of base
128—Notch
130—Main body of first clamp structure
132—First end of main body
134—Second end of main body
136—Cross dimension of main body
138—Ridge of first clamp structure
140—Throughhole
142—Spacing on top side of base
144—Tabs of cover
146—Bottom side of cover
148—Cutout of first clamp structure
150—Clamp mount for 2^{nd} embodiment of strain relief device/cable clamp

1. A strain relief device (24) for anchoring a fiber optic cable (22) to telecommunications equipment (10), the strain relief device (24) comprising:
a base (34) defining a top side (52) and a bottom side (54), the base (34) defining a base channel (60) having an open top and a closed bottom and configured to receive at least a portion of the fiber optic cable (22) from the open top, the base channel (60) defining a longitudinal axis (62) generally parallel to a longitudinal axis (82) of the fiber optic cable (22) when the fiber optic cable (22) is placed within the base channel (60), the base (34) further defining a first sliding coupling structure (66) extending at a generally acute angle with respect to the longitudinal axis (62) of the base channel (60) along a top to bottom direction; and
a cover (44) defining a top side and a bottom side, the cover (44) defining a cover channel (80) having an open bottom and a closed top and configured to receive at least a portion of the fiber optic cable (22) from the open bottom, the cover channel (80) defining a longitudinal axis (78) generally parallel to the longitudinal axis (82) of the fiber optic cable (22) when the fiber optic cable (22) is placed within the cover channel (80), the cover (44) further defining a second sliding coupling structure (68) extending at a generally acute angle with respect to the longitudinal axis (78) of the cover channel (80) along a top to bottom direction, the second sliding coupling structure (68) of the cover (44) configured to slidably mate with the first sliding coupling structure (66) of the base (34) for advancing the closed top of the cover channel (80) toward the closed bottom of the base channel (60) to clamp the fiber optic cable (22) in between the base (34) and the cover (44).

2. A strain relief device (24) according to claim 1, wherein the base (34) defines a plurality of teeth (64) protruding into the base channel (60) for digging into an outer jacket (38) of the fiber optic cable (22) during clamping.

3. A strain relief device (24) according to claim 1, wherein the strain relief device (24) is configured to be removably mounted to the telecommunications equipment (10) and includes a snap-fit structure for removable mounting to the telecommunications equipment (10).

4. A strain relief device (24) according to claim 3, wherein the snap-fit structure includes an elastically flexible cantilever arm (28).

5. A strain relief device (24) according to claim 4, further comprising a strength member retaining structure (84) for wrapping a strength member (40) of the fiber optic cable (22) before the fiber optic cable (22) is clamped.

6. A strain relief device (24) according to claim 1, wherein the base (34) includes a removable insert (46), the insert (46) being replaceable by another insert having a different sized channel (95) for accommodating a cable (22) having an outer jacket (38) of a different diameter (42).

7. A strain relief device (24) according to claim 1, wherein the strain relief device (24) is mounted to a fiber optic splice tray (10).

8. A strain relief device (24) according to claim 1, wherein each of the base channel (60) and the cover channel (80) defines a V-shaped transverse cross-sectional shape.

9. A method of using the strain relief device (24) of claim 1.

10. A strain relief device (100) for anchoring a fiber optic cable (22) to telecommunications equipment (10), the strain relief device (100) comprising:
a base (106) defining a bore (110) having a tapered profile, wherein the bore (110) defines a larger cross dimension (124) at a first end (112) than at a second end (114) of the bore (110);
a clamp structure (104) defining a body (130) configured for insertion into the bore (110), the body (130) defining a tapered profile, wherein the body (110) defines a larger cross dimension (136) at a first end (132) than at a second end (134) of the body (130), the clamp structure (104) further including a throughhole (140) extending generally along a direction from the first end (132) to the second end (134) of the body (130) for receiving a fiber optic cable (22);
wherein the base (106) and the clamp structure (104) are configured such that when the clamp structure (104) is slidably inserted into the bore (110) in a direction extending from the first end (112) toward the second end (112) of the bore (110), a fiber optic cable (22) extending through the throughhole (140) of the clamp structure (104) is radially clamped within the clamp structure (104).

11. A strain relief device (100) according to claim 10, further comprising a cover (108) configured to snap-fit over the base (106) to capture the clamp structure (104) with respect to the base (106) to limit movement of the clamp structure (104) along a direction extending from the first end (112) to the second end (114) of the bore (110).

12. A strain relief device (100) according to claim 10, wherein the base (106) is configured for snap-fitting on top of another similarly configured base (106) for providing a stacked arrangement.

13. A strain relief device (100) according to claim 10, wherein the base (106) defines a keying structure in the form of an elongate groove (126) and the clamp structure (104) includes a second keying structure in the form of an elongate ridge (138) that is configured to slidably fit within the elongate groove (126).

14. A strain relief device (100) according to claim 10, wherein each of the bore (110) and the body (130) defines a generally conical shape.

15. A strain relief device (100) according to claim 10, wherein the bore (110) defines a notch (128) for accommodating a strength member (40) of a fiber optic cable (22) that is to be positioned in the bore (110) between the body (130) and the base (106).

16. A strain relief device (100) according to claim 10, wherein the strain relief device (100) is configured to be removably mounted to the telecommunications equipment (10) and includes a snap-fit structure for removable mounting to the telecommunications equipment (10).

17. A strain relief device (100) according to claim 16, wherein the snap-fit structure includes an elastically flexible cantilever arm (102).

18. A strain relief device (100) according to claim 10, wherein the base (106) defines a plurality of bores (110) for receiving a plurality of the clamp structures (104), each clamp structure (104) configured to clamp a separate fiber optic cable (22).

19. A strain relief device (100) according to claim 10, wherein the strain relief device (100) is mounted to a fiber optic splice tray (10).

20. A method of using the strain relief device (100) of claim 10.
